(19) United States
(12) Patent Application Publication
(10) Pub. No.: US 2008/0072834 A1
(43) Pub. Date: Mar. 27, 2008

(54) Electronic Housebreaking Systems & Methods

(76) Inventor: Judith Makem, Lake Forest, CA (US)

Correspondence Address: FISH & ASSOCIATES, PC;ROBERT D. FISH, 2603 Main Street, Suite 1050, Irvine, CA, 92614-6232, US

(21) Appl. No.: 11/839,114

(22) Filed: Aug. 15, 2007

Related U.S. Application Data
(60) Provisional application No. 60/846,794, filed on Sep. 22, 2006.

(51) Int. Cl. A01K 29/00

(52) U.S. Cl. 119/169

(57) ABSTRACT

A urine pad has a hard upper layer, and a sensor positioned to sense urine deposited onto the pad. In preferred embodiments, the pad comprises at least bottom, intermediate, and top layers, where the bottom layer comprises a liquid impermeable material, structured to prevent passage of urine, the intermediate layer comprises a liquid absorbent material, and the top layer comprises a durable material that is sufficiently hard to resist chewing by a dog; and structured so that deposition of the urine on the top sheet will pass through to the intermediate layer.

This application claims priority to Provisional App. No. 60/846,794 filed Sep. 22, 2006.

### FIELD OF THE INVENTION

The field of the invention is urine pads (128/886, 604/361).

### BACKGROUND

There are numerous devices and methods for house-training dogs. U.S. Pat. No. 5,226,386 to Thoma (July 1993) and U.S. Pat. No. 5,662,640 to Daniels (September 1997) teach doggie diapers that produces an alarm or other negative feedback when the urine causes electrodes inside the fabric to close. Such devices are problematic, however, in that they must be worn by the animal.

U.S. Pat. No. 5,117,780 to Wooten et al. (June 1992) teaches an enclosure with a pet toilet, but such devices are cumbersome, and are difficult to transfer the potty training to ordinary evacuation outdoors.

Urine pads designed for humans could be adapted for use in training dogs. But such pads are completely inadequate for dogs because they always use a soft top sheet that can readily be chewed or ripped by the dog. See, e.g., U.S. Pat. No. 5,291,181 to DePonte (March 1994).

There are specialized dog urine pads with a hard upper layer. U.S. Pat. No. 7,128,023 to Otsuji et al. (October 2006), for example, teaches an animal urine pad with a scratch resistant upper layer. But such pads are inadequate for training because they lack a feedback mechanism.

The animal pads that do have a feedback mechanism, for example, each teach a urine pad with a moisture or temperature activated sensor, but none have appreciated the value of a hard upper layer. See e.g., WO 02/17709 to Armstrong (publ. March 2002), and WO 2006/083123 to Huh (publ. August 2006). Armstrong teaches a steel intermediate layer, but covers the steel with a fabric upper layer that presumably can be ripped or chewed apart. Huh merely teaches a top layer as a “support means to allow the pets to evacuate in a stable condition”.

Thoma, Daniels, Wooten, DePonte, Otsuji, Armstrong, and Huh and all other referenced patents and applications are incorporated herein by reference in their entirety. Where a definition or use of a term in a reference, which is incorporated by reference herein is inconsistent or contrary to the definition of that term provided herein, the definition of that term provided herein applies and the definition of that term in the reference does not apply.

In view of the shortcomings of the prior art, there is still a need for systems, methods and apparatus, in which a dog urine pad provides positive feedback and is better adapted for use by dogs. Of course, those skilled in the art will appreciate that references to dogs herein are used emblematically for references to many other animals, including for example, rabbits, monkeys, and pot bellied pigs.

### SUMMARY OF THE INVENTION

The present invention provides apparatus, systems and methods in which a urine pad has a hard upper layer, and a sensor positioned to sense urine deposited onto the pad.

In preferred embodiments, the pad comprises at least bottom, intermediate, and top layers, where the bottom layer comprises a liquid impermeable material, structured to prevent passage of urine, the intermediate layer comprises a liquid absorbent material, and the top layer comprises a durable material that is sufficiently hard to resist chewing by a dog; and structured so that deposition of the urine on the top sheet will pass through to the intermediate layer.

Each of the layers is preferably a sheet, and the layers have a thickness measuring no more than about 20 mm, more preferably no more than 10 mm, and most preferably no more than 5 mm. From a plan view, preferred pads measure between about 0.5-1.5 m in length and between about 0.5 and 1.5 m in width. Bigger pads are contemplated for bigger animals, and smaller pads are contemplated for smaller animals.

The various layers of contemplated pads can be made from any suitable material or materials. For example, the liquid impermeable material can advantageously comprise a sheet of plastic or other polymer that is typically used as a backing for urine pads for humans. Similarly, the absorbent material can advantageously comprise a cellulose such as that used in diapers and sanitary napkins. Still further, the durable top material can advantageously comprise a plastic selected from the group consisting of an acrylic, and a nylon.

All suitable sensors are contemplated, including especially those used in urine pads for humans. A given pad can have one or multiple sensors, which can be the same or different types of sensors. Of particular interest are temperature and moisture sensors.

Pads can also advantageously include a scent that can be used by the dog as an anchor to identify the proper place to urinate.

Contemplated method of house training a dog (or other animal) includes: establishing an enclosure for the dog at a first location; placing a pad according to the present invention in the enclosure; and giving the dog a reward for urinating on the pad. Positive feedback is especially contemplated, for example where a dog is provided with a clicker or other positive reinforcement sound for urinating on the pad. Other contemplated rewards include toys, food or other treats. Consistent with currently accepted training concepts, the reward(s) can be attenuated over time, in frequency, amount, type, or in some other suitable manner. The pads can eventually be moved outdoors or to some other location where the dog is intended to urinate. If done properly, the dog should be able to generalize the training.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a perspective view of an exemplary configuration of a urine pad and a food/treat/reward dispenser.

FIG. 2 is a block diagram illustrating the steps of a method of a house training a dog using the urine pad of FIG. 1.

### DETAILED DESCRIPTION

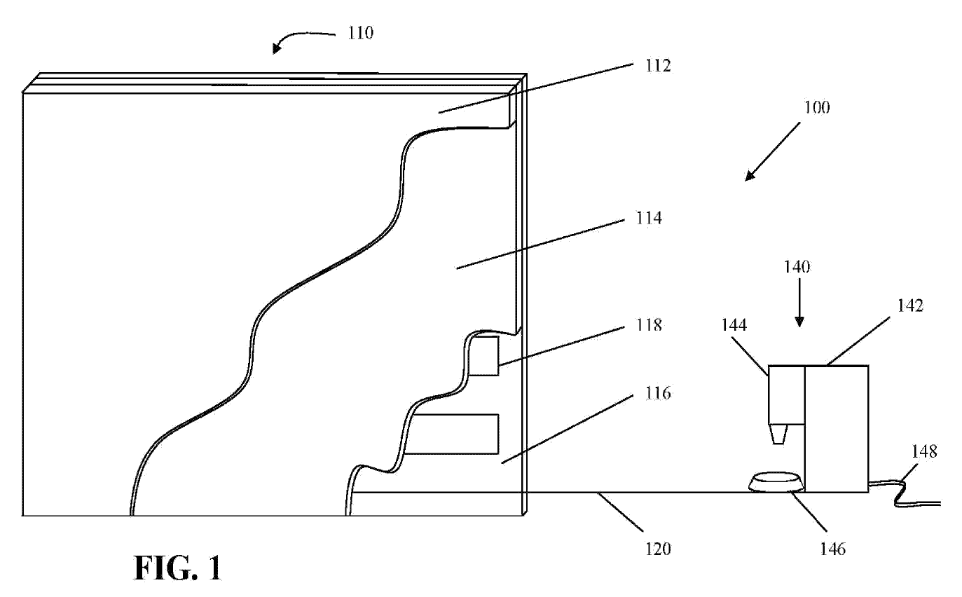

FIG. 1 illustrates an exemplary inventive configuration of a house training system 100 depicted generally as having a urine pad 110, and a food/treat/reward dispenser 140 electrically coupled to urine pad 110 via electrical connection 120.

Urine pad 110 is depicted generally as having a bottom layer 116, an intermediate layer 114, a top layer 112, where the bottom layer 116 comprises a liquid impermeable material, structured to prevent passage of urine, the intermediate layer 114 comprises a liquid absorbent material, and the top layer 112 comprises a durable material that is sufficiently hard to resist chewing by a dog; and structured so that deposition of the urine on top layer 112 will pass through to intermediate layer 114.

Each of the layers is preferably a sheet, and the layers have a thickness measuring no more than about 20 mm, more preferably no more than 10 mm, and most preferably no more than 5 mm. From a plan view, preferred pads measure between about 0.5-1.5 m in length and between about 0.5 and 1.5 m in width. Bigger pads are contemplated for bigger animals, and smaller pads are contemplated for smaller animals.

The various layers of contemplated pads 110 can be made from any suitable material or materials. For example, the liquid impermeable material of bottom layer 116 can advantageously comprise a sheet of plastic or other polymer that is typically used as a backing for urine pads for humans. Similarly, the absorbent material of intermediate layer 114 can advantageously comprise a cellulose such as that used in diapers and sanitary napkins. Still further, the durable material of top layer 112 can advantageously comprise a plastic selected from the group consisting of an acrylic, and a nylon.

Sensor 118 is preferably disposed between intermediate layer 114 and bottom layer 116 to sense urine deposited onto pad 110. Alternatively, sensor 118 can be disposed between top layer 112 and intermediate layer 114. All suitable sensors are contemplated, including especially those used in urine pads for humans, such as, temperature and moisture sensors and other suitable sensors for detecting urine. Additionally urine pad 110 can have one or multiple sensors, which can be the same or different types of sensors.

Urine pad 110 can also advantageously include a scent that can be used by the dog as an anchor to identify the proper place to urinate.

Food/treat/reward dispenser 140 is depicted generally as having, a container 142 for holding food/treat/rewards, a dispensing mechanism 144 for dispensing food/treat/rewards, a food/treat/reward dish 146, and a power supply 148 for powering dispenser 140.

It is contemplated that container 142 can be any suitable container used to hold food, treats, and other rewards, such as a screw top container (not shown). Dispensing mechanism 144 can be any suitable dispensing mechanism commonly known in the art.

In order to provide positive feedback to a dog for urinating on pad 110. Sensor(s) 118 is electrically coupled to food/treat/reward dispenser 140 via electrical connection 120. Sensor(s) 118 senses urine deposited on pad 110, which triggers dispensing mechanism 144 powered by power supply 148 to dispense food/treat/rewards into dish 146.

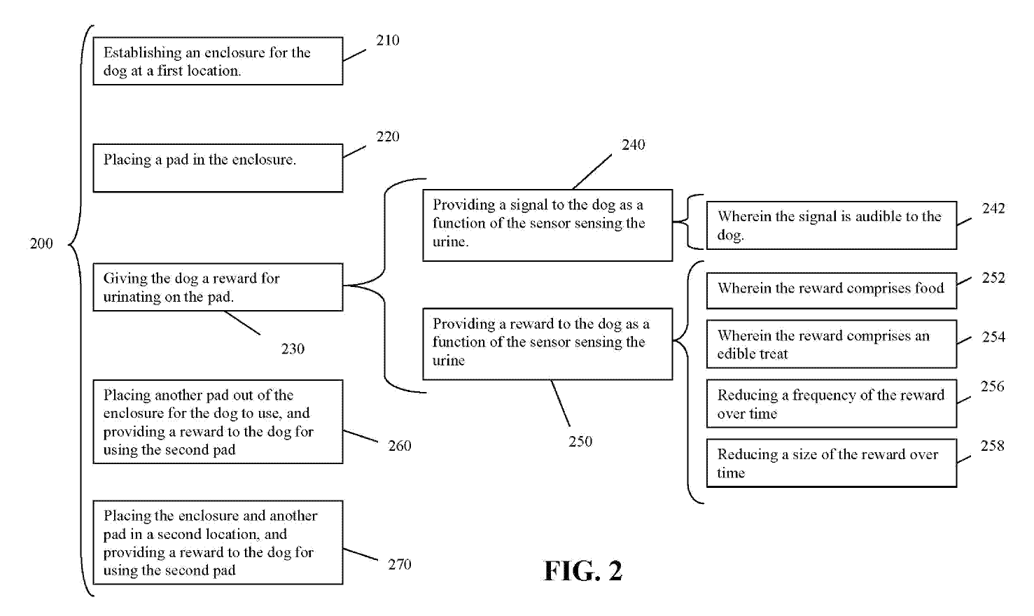

FIG. 2 is a block diagram illustrating the steps of a method 200 for potty training a dog using house training system 100 of FIG. 1. Contemplated method 200 of potty training a dog (or other animal) includes: (a) establishing an enclosure for the dog at a first location 210; (b) placing a urine pad according to the present invention in the enclosure 220; (c) giving the dog a reward for urinating on the pad 230, such as toys, food, or other treats; (d) placing another pad out of the enclosure for the dog to use, and providing a reward to the dog for using the second pad 260; and (e) the step of placing the enclosure and another pad in a second location (such as outside), and providing a reward to the dog for using the second pad 270. If done properly, the dog should be able to generalize the training.

Positive feedback is especially contemplated, such as: (a) providing a signal to the dog as a function of the sensor sensing the urine 240, wherein the signal is an audible signal 242; and (b) providing a reward to the dog as a function of the sensor sensing the urine 250, wherein the reward comprises food 252, or edible treats 254. Consistent with currently accepted training concepts, the frequency of the reward(s) can be reduced over time 258, and/or the size of the reward can be reduced over time 258.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A pad, comprising:
a lower layer comprising a liquid impermeable material, structured to prevent passage of urine;
an intermediate layer comprising a liquid absorbent material;
a top layer comprising a durable material that is sufficiently hard to resist chewing by a dog; and structured so that deposition of the urine on the top sheet will pass through to the intermediate layer; and
a sensor positioned to sense urine deposited onto the pad.

2. The pad of claim 1, wherein the liquid impermeable material comprises a polymer.

3. The pad of claim 1, wherein the absorbent material comprises a cellulose.

4. The pad of claim 1, wherein the durable material comprises a plastic selected from the group consisting of an acrylic, and a nylon.

5. The pad of claim 1, wherein the sensor comprises a temperature sensor.

6. The pad of claim 1, wherein the sensor comprises a moisture sensor.

7. The pad of claim 1, wherein the pad further comprises a scent.

8. A method of house training a dog, comprising:
establishing an enclosure for the dog at a first location;
placing a pad according to claim 1 in the enclosure; and
giving the dog a reward for urinating on the pad.

9. The method of claim 8, further comprising providing a signal to the dog as a function of the sensor sensing the urine.

10. The method of claim 9, wherein the signal is audible to the dog.

11. The method of claim 8, further comprising providing a reward to the dog as a function of the sensor sensing the urine.

12. The method of claim 11, wherein the reward comprises food.

13. The method of claim 11, wherein the reward comprises an edible treat.

14. The method of claim 11, further comprising reducing a frequency of the reward over time.

15. The method of claim 11, further comprising reducing a size of the reward over time.

16. The method of claim 8, further comprising placing another pad out of the enclosure for the dog to use, and providing a reward to the dog for using the second pad.

17. The method of claim 8, further comprising placing the enclosure and another pad in a second location, and providing a reward to the dog for using the second pad.
